(19) United States
(12) Patent Application Publication
(10) Pub. No.: US 2007/0105545 A1
(43) Pub. Date: May 10, 2007

(54) Color coding recent call list entries

(75) Inventors: Pawel Czeremuga, Addison, IL (US); Naum Spektor, Glenview, IL (US); Ilya Ushomirsky, Chicago, IL (US); Igor Velyunskiy, Buffalo Grove, IL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/267,238

(22) Filed: Nov. 4, 2005

(51) Int. Cl. H04M 3/00

(52) U.S. Cl. 455/423; 455/418

(57) ABSTRACT

A method (100 or 200) of color coding recent call list entries in a recent call list can include receiving or initiating (102) a call, storing a number or other indicia associated with the call as an entry in the recent call list, determining (104) if a call set up was successful, and color coding the entry in the recent call list based on the step of determining. The method can color code (108) the entry green if the call setup was successful and color code (107) the entry red if unsuccessful. The method can store a caller identifier number or other indicia of a missed call in the recent call list when a call is missed (204). In such an instance, the method can color code (206) the caller identifier number or other indicia as the entry with the recent call list with the color orange for example.

### FIELD

This invention relates generally to call lists, and more particularly to a color coding call list.

### BACKGROUND

Currently used recent call lists utilize graphical icons to represent contacts based on various categories such as sent calls, received calls, or missed calls. Such listing is sometimes difficult to distinguish, particularly on smaller black and white screens.

### SUMMARY

Embodiments in accordance with the present invention can enable color coding of Recent Call List entries on mobile devices. Such mobile devices or wireless communication devices can dynamically allow the storing of telephony or dispatch contact information or other contact information in a Recent Call List using different color codes. The contacts in the Recent Call list can be color coded based on the success or failure status of the telephony or dispatch call or can be color coded based on other status information. Such color coding of Recent Call List entries can easily enable a device user to visually determine which calls in the Recent Call List were successfully connected and which ones failed to connect. The color codes can also possibly provide an indication as to why such calls failed to connect. For example, some calls could have failed to connect due to network errors or due to user unavailability and corresponding color codes can be assigned based on the status of such calls.

In a first embodiment of the present invention, a method of color coding recent call list entries in a recent call list can include the steps of receiving or initiating a call, storing a number or other indicia associated with the call as an entry in the recent call list, determining if a call set up was successful, and color coding the entry in the recent call list based on the step of determining. The method can return to the recent call list after color coding the entry. The method can further include the step of waiting for the call to end if the call set up was successful before color coding the entry. The method can further include the step of color coding the entry green if the call setup was successful and color coding the entry red if the call setup was unsuccessful. The method can further include the step of determining the reason for a call set-up failure using an internal error code table. In another aspect, the method can further include the step of storing a caller identifier number or other indicia of a missed call as the entry in the recent call list when a call is missed. In such an instance, the method can color code the caller identifier number or other indicia as the entry with the recent call list with the color orange.

In a second embodiment of the present invention, another method of color coding recent call list entries in a recent call list can include the steps of receiving or initiating a call, storing a number or other indicia associated with the call as an entry in the recent call list, determining if a call set up was successful, unsuccessful or a missed call, and color coding the entry in the recent call list based on the step of determining. The method can include the steps of color coding the entry in the recent call list a first color if the call set up was successful, a second color if the call set up was unsuccessful, and a third color if the call was a missed call. The first color can be green, the second color can be red, and the third color can be orange although any color in any combination can be used to designate a particular status for an entry in a recent call list.

In a third embodiment of the present invention, a wireless communication device can include a transceiver, a color display, and a processor coupled to the transceiver and color display. The processor can be programmed to receive or initiate a call, store a number or other indicia associated with the call as an entry in a recent call list, determine if a call set up was successful, and color code the entry in the recent call list based on whether the call set up was successful. The processor can be programmed to return to the recent call list after color coding an entry. The processor can be further programmed to wait for the call to end if the call set up was successful before color coding the entry. The processor can be further programmed to color code the entry green if the call setup was successful or color code the entry red if the call setup was unsuccessful. The processor can determine the reason for a call set-up failure using an internal error code table store in a memory. In the case where a call is missed, the processor can be programmed to store a caller identifier number or other indicia of a missed call as the entry in the recent call list. The processor can color code the caller identifier number or other indicia as the entry with the recent call list with the color orange if desired. Again, the colors noted are provided as examples and should not be determined as the dispositive color that can be used in any particular embodiment. No such limitation is implied in the broadest claims by claiming the particular colors herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is flow chart illustrating a method of color coding a recent call list entry in accordance with an embodiment of the present invention.

FIG. 2 is another flow chart illustrating a method of color coding a recent call list entry in accordance with an embodiment of the present invention.

FIG. 3 is a wireless communication device in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

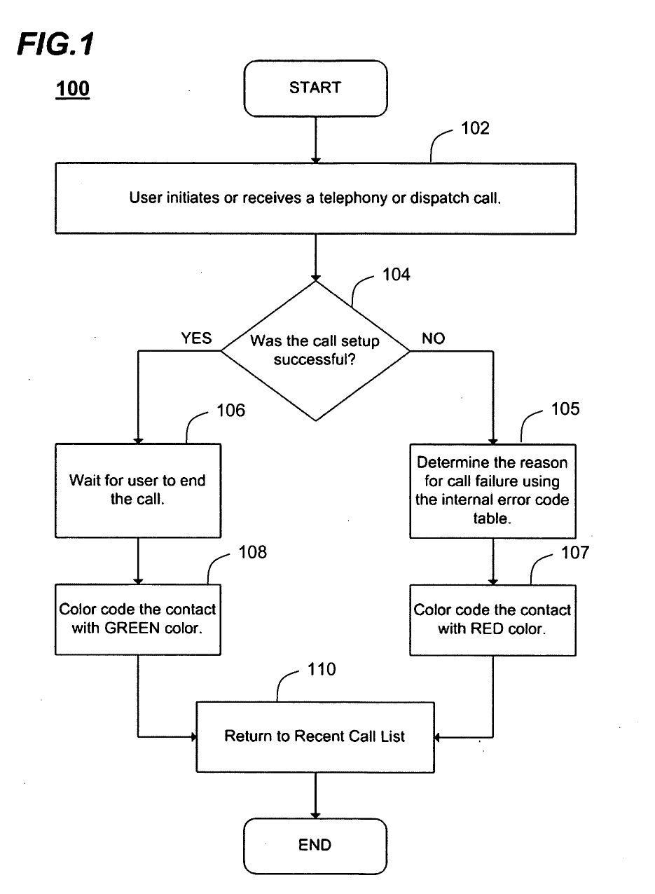

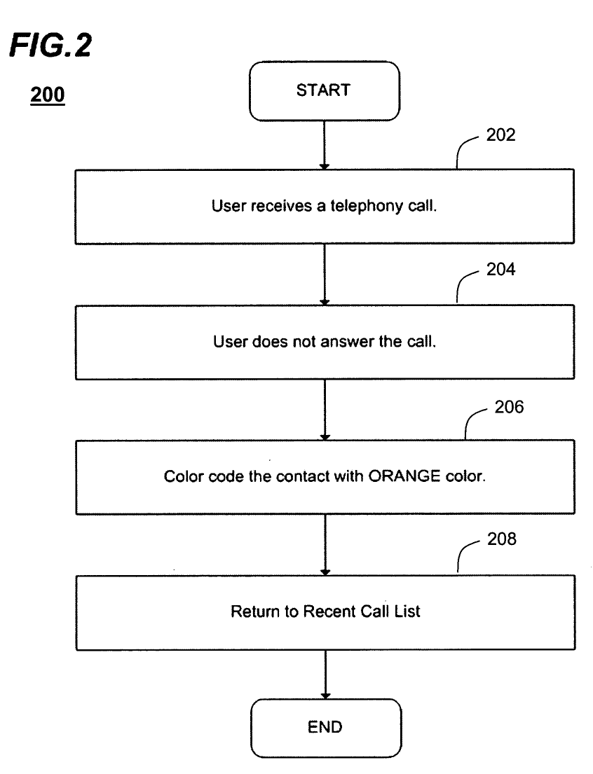

Referring to FIGS. 1 and 2, a method 100 or 200 of color coding Recent Call List entries for mobile devices can dynamically enable a software application running on the mobile device to store telephony or dispatch contact information in the Recent Call List using different color codes. For example, if a user initiates or receives a telephony or dispatch call at step 102, then a determination can be made at decision block 104 whether the call setup was successful. If the call was successful, the method can optionally wait for the user to end the call at step 106 before assigning a specific color at step 108 to the call, number or whatever indicia used to represent the entry in the recent call that has been successfully set up. In this specific embodiment, the successfully originated and terminated telephony or dispatch call can be color coded using a green color for example. Once the color is assigned, the method returns to the recent call list at step 110. If the call setup is unsuccessful at decision block 104, then the method can optionally determine the reason for the call failure using an internal error code table at step 105. Failed originated telephony or dispatch calls can be assigned a different color than successful calls at step 107. In this particular embodiment, failed call setups can be color coded using a red color for example. Failed originated calls are calls that failed due to channel assignment failure, network failure, paging time out, or other reasons that might not fall under the category of a missed call as described further below.

Referring to the method 200 of FIG. 2, a user can receive a call at step 202 but fail to answer the call at step 204. Missed telephony calls can be color coded using yet another color such as ORANGE at step 206. Once the color code has been assigned for the missed call, the method can return to the recent call list at step 208. Note, calls that left a voicemail can also be color coded with yet another color if desired.

Color coding Recent Call Lists in mobile devices can supplement current methods of storing contacts in Recent Call Lists by adding color coding techniques. Such color coding can enhance a user's visual experience viewing the contacts in a Recent Call List. Certain colors, such as the colors green, red, and orange, can be more dominant and easily understandable by a user. Small graphical icons currently used in some mobile devices are not very dominant and don't catch user's attention very well. In this manner, color coding a Recent Call List can allow a user to quickly determine successful, missed, or failed calls using different color codes. The method of color coding a Recent Call List can be applied to any cellular mobile device capable of telephony or dispatch call processing and equipped with a color LCD screen. Most modern cellular mobile devices currently used on the market meet these criteria. Notwithstanding, there can be other communication devices besides cellular phones that can also benefit from the techniques contemplated herein such as laptop computers, personal digital assistants, smart phones, and other devices that can potentially use a Recent Call List.

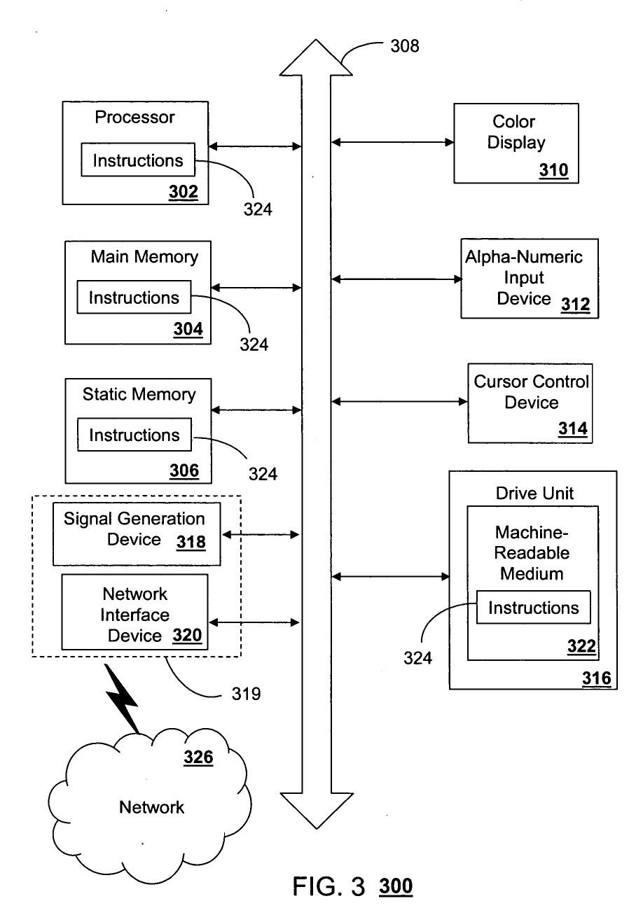

Referring to FIG. 3, an electronic product in the form of a computer system 300 that can be part of a communication device can include a processor 302 (e.g., a central processing unit (CPU), a graphics processing unit (GPU, or both), a main memory 304 and a static memory 306, which communicate with each other via a bus 308. Note, the main memory 304 can include the internal error code table. The computer system 300 may further include a video display unit 310 (e.g., a liquid crystal display (LCD), a flat panel, a solid state display, or a cathode ray tube (CRT)) that operates in color. The computer system 300 may include an input device 312 (e.g., a keyboard or keypad), a cursor control device 314 (e.g., a mouse or touchpad), a disk drive unit 316, a signal generation device 318 (e.g., a speaker or remote control or microphone) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320. Note, the signal generation device 318 and network device 320 can be a transceiver 319 that is either wired or wireless.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of color coding recent call list entries in a recent call list, comprising the steps of:
receiving or initiating a call;
storing a number or other indicia associated with the call as an entry in the recent call list;
determining if a call set up was successful; and
color coding the entry in the recent call list based on the step of determining.

2. The method of claim 1, wherein the method further comprises the step of waiting for the call to end if the call set up was successful before color coding the entry.

3. The method of claim 1, wherein the method further comprises the step of color coding the entry green if the call setup was successful.

4. The method of claim 1, wherein the method further comprises the step of determining the reason for a call set-up failure using an internal error code table.

5. The method of claim 1, wherein the method further comprises the step of color coding the entry red if the call setup was unsuccessful.

6. The method of claim 1, wherein the method further comprises the step of returning to the recent call list after color coding the entry.

7. The method of claim 1, wherein the method further comprises the step of missing a call and storing a caller identifier number or other indicia of a missed call as the entry in the recent call list.

8. The method of claim 7, wherein the method further comprises the step of color coding the caller identifier number or other indicia as the entry with the recent call list with the color orange.

9. A method of color coding recent call list entries in a recent call list, comprising the steps of:
receiving or initiating a call;
storing a number or other indicia associated with the call as an entry in the recent call list;
determining if a call set up was successful, unsuccessful or a missed call; and
color coding the entry in the recent call list based on the step of determining.

10. The method of claim 9, wherein the method further comprises the step of color coding the entry in the recent call list a first color if the call set up was successful, a second color if the call set up was unsuccessful, and a third color if the call was a missed call.

11. The method of claim 10, wherein the first color is green, the second color is red, and the third color is orange.

12. A wireless communication device, comprising:
a transceiver;
a color display;
a processor coupled to the transceiver and color display, wherein the processor is programmed to:
receive or initiate a call;
store a number or other indicia associated with the call as an entry in a recent call list;
determine if a call set up was successful; and
color code the entry in the recent call list based on whether the call set up was successful.

13. The wireless communication device of claim 12, wherein the processor is further programmed to wait for the call to end if the call set up was successful before color coding the entry.

14. The wireless communication device of claim 12, wherein the processor is further programmed to color code the entry green if the call setup was successful.

15. The wireless communication device of claim 12, wherein the processor is further programmed to determine the reason for a call set-up failure using an internal error code table store in a memory.

16. The wireless communication device of claim 12, wherein the processor is further programmed to color coding the entry red if the call setup was unsuccessful.

17. The wireless communication device of claim 12, wherein the processor is further programmed to return to the recent call list after color coding the entry.

18. The wireless communication device of claim 12, wherein the processor is further programmed to store a caller identifier number or other indicia of a missed call as the entry in the recent call list when missing the call.

19. The wireless communication device of claim 18, wherein the processor is programmed to color code the caller identifier number or other indicia as the entry with the recent call list with the color orange.
